(19) United States
(12) Patent Application Publication
(10) Pub. No.: US 2024/0351223 A1
(43) Pub. Date: Oct. 24, 2024

(54) ROBOT HAND AND ROBOT SYSTEM

(71) Applicant: HITACHI, LTD., Tokyo (JP)

(72) Inventor: Shotaro MORI, Tokyo (JP)

(21) Appl. No.: 18/685,662

(22) PCT Filed: Jul. 21, 2022
(86) PCT No.: PCT/JP22/28299

§ 371 Date: Feb. 22, 2024

(30) Foreign Application Priority Data
Aug. 31, 2021 (JP) 2021-140592

(51) Int. Cl. B25J 15/10

(52) U.S. Cl. CPC B25J 15/10

(57) ABSTRACT

A robot hand and system are mounted with a plurality of actuators and reduced in size and weight while having both a gripping force required for heavy work and controllability required for light work. The robot hand includes a finger part and a driving unit. The driving unit includes: a plurality of driving actuators; and a driving force transmission part that transmits driving forces of the plurality of driving actuators to the finger part. The driving force transmission part includes: a disconnection mechanism that selectively switches between a coupling state in which some of the plurality of driving actuators and the finger part are coupled and a release state in which the coupling between the some of the driving actuators and the finger part is released to switch between transmission of a driving force of the some of the driving actuators to the finger part and cut-off thereof.

### TECHNICAL FIELD

The present invention relates to a robot hand and a robot system that achieve both heavy work requiring a large gripping force and light work requiring controllability.

### BACKGROUND ART

In robot automation that has been carried on in recent years in manufacturing, distribution, plants, nuclear power plants, and the like, a robot hand to be used is required a lot, such as positioning with respect to an operation target, and a large gripping force. On the other hand, from a viewpoint of cost, throughput, work space, and the like, it is desired to perform work with a small number of robot hands rather than performing work while preparing and replacing a plurality of robot hands.

As background art of the present technical field, for example, there is such a technique as recited in PTL 1. PTL 1 discloses “A new high-performance drive device that combines superiority of both an actuator such as a pneumatic actuator capable of obtaining large force and torque and an actuator such as an electric motor excellent in control of position and speed, and does not require advanced control of the former actuator”.

### CITATION LIST

### Patent Literature

PTL 1: JP 2011-104673 A

### SUMMARY OF INVENTION

### Technical Problem

However, such a configuration in which a plurality of actuators is mounted and simply connected as in the drive device described in PTL 1 has a problem that the entire device becomes huge and heavy.

Therefore, an object of the present invention is to provide a robot hand and a robot system that are mounted with a plurality of actuators and can be reduced in size and weight while having both a gripping force required for heavy work and controllability required for light work.

### Solution to Problem

In order to solve the above problem, the present invention provides a robot hand including a finger part and a driving unit that drives the finger part. The driving unit includes: a plurality of driving actuators; and a driving force transmission part that transmits driving forces of the plurality of driving actuators to the finger part. The driving force transmission part includes: a disconnection mechanism that selectively switches between a coupling state in which some of the plurality of driving actuators and the finger part are coupled and a release state in which the coupling between the some of the driving actuators and the finger part is released to switch between transmission of a driving force of the some of the driving actuators to the finger part and cut-off thereof.

### Advantageous Effects of Invention

According to the present invention, with respect to some of the actuators, by transmitting a driving force to the finger part only when a target object is gripped, a stroke required for operation can be greatly reduced. Therefore, it is possible to realize a robot hand having excellent gripping force and controllability while being small in size and light in weight. This enables an actuator that is very light in weight but has a small contraction rate, such as an artificial muscle, to be satisfactorily used, so that further weight reduction can be expected.

In addition, it is possible to achieve both light work and heavy work by a single robot hand, and cost reduction, throughput improvement, and work space reduction of a robot system can be expected.

Further characteristics related to the present invention will become apparent from description of the present specification and the accompanying drawings. In addition, problems, configurations, and effects other than those described above will be clarified by the following description of embodiments.

### BRIEF DESCRIPTION OF DRAWINGS

FIG. 1 is a view illustrating a schematic configuration of a robot hand according to a first embodiment of the present invention.

FIG. 2 is a perspective view illustrating a specific example of the robot hand according to the first embodiment of the present invention.

FIG. 3A is a perspective view illustrating an internal configuration of a finger part of the robot hand of FIG. 2 as viewed from a front side.

FIG. 3B is a perspective view illustrating the internal configuration of the finger part of the robot hand of FIG. 2 as viewed from a back side.

FIG. 4 is a diagram illustrating a control system configuration of an electric motor and a pneumatic artificial muscle used in the robot hand of FIG. 2.

FIG. 5A is a view for explaining transmission and cut-off of pneumatic power of the robot hand of FIG. 2.

FIG. 5B is a view for explaining the transmission and the cut-off of the pneumatic power of the robot hand of FIG. 2.

FIG. 6 is a view illustrating a state in which gears are not meshed to fail in connection at the time of transmitting the pneumatic power of the robot hand of FIG. 2.

FIG. 7 is a view illustrating an overall configuration when the robot hand of FIG. 2 is connected to a robot arm to grip a long object.

FIG. 8 is a flowchart showing a method of controlling the robot hand according to the first embodiment of the present invention.

FIG. 9 is a view illustrating a state in which the fingers are opened so that the gears mesh with each other before the robot hand according to the first embodiment of the present invention grips the long object.

FIG. 10 is a view illustrating a schematic configuration of a robot hand according to a second embodiment of the present invention.

### DESCRIPTION OF EMBODIMENTS

In the following, embodiments of the present invention will be described with reference to the drawings. In the drawings, the same components are denoted by the same reference signs, and detailed description of overlapping parts is omitted.

### First Embodiment

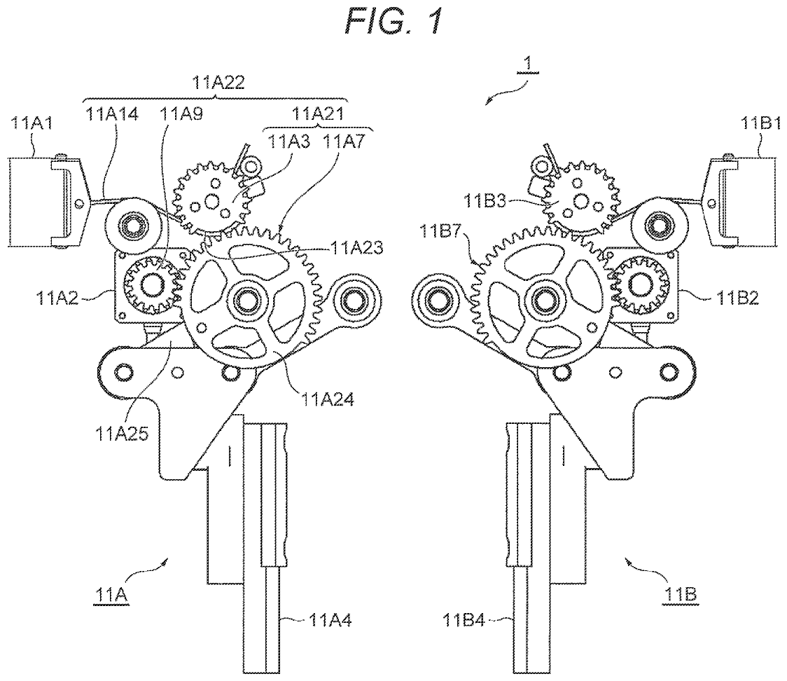

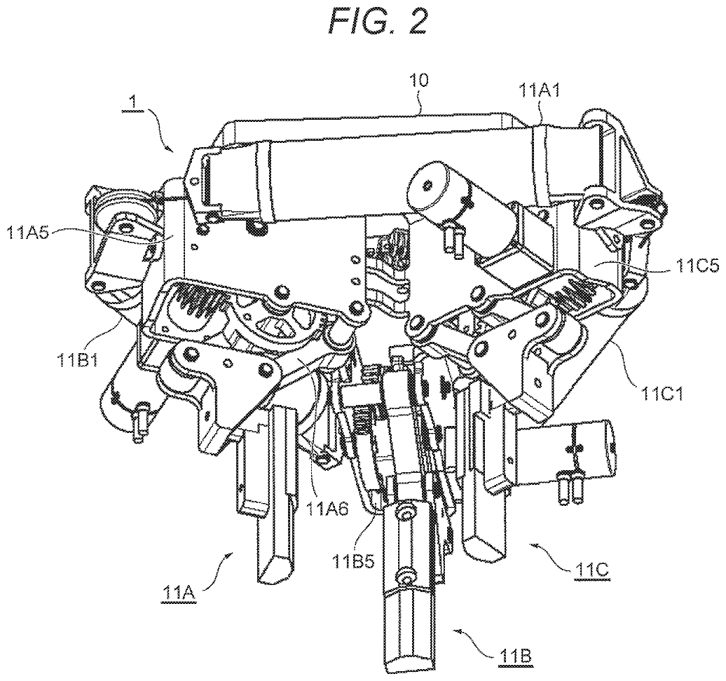

A robot hand according to a first embodiment of the present invention will be described with reference to FIGS. 1 to 9. FIG. 1 is a view illustrating a schematic configuration of a robot hand 1 according to the first embodiment of the present invention. As shown in FIG. 1, the robot hand 1 of the present embodiment has a plurality of finger parts 11A and 11B that can grip a grip target object between the finger parts. Since the finger parts 11A and 11B have the same configuration, only the finger part 11A will be described below. The same applies to FIG. 2 and the subsequent drawings. In addition, in order to avoid complication on the drawings, illustration of some reference signs may be omitted for parts other than the finger part 11A in some cases.

The finger part 11A has a fingertip part 11A4, and is connected to a high-output actuator 11A1 and a low-output actuator 11A2 via a driving force transmission part 11A22 (here, an intermittent gear 11A3, a chemical fiber wire 11A14, a geared finger link 11A7, and an electric motor gear 11A9). Note that the high-output actuator 11A1, which is a first actuator, is desirably a linear motion actuator, and the low-output actuator 11A2, which is a second actuator, is desirably a motor. In the present embodiment, description will be made of an example in which a pneumatic artificial muscle is adopted as the high-output actuator 11A1 and an electric motor is adopted as the low-output actuator 11A2.

As described above, the driving force transmission part includes the intermittent gear 11A3 and the chemical fiber wire 11A14, and the geared finger link 11A7 and the electric motor gear 11A9. A driving force of the low-output actuator 11A2 is transmitted to the fingertip part 11A4 via the electric motor gear 11A9 and the geared finger link 11A7. A driving force of the high-output actuator 11A1 is transmitted to the fingertip part 11A4 via the chemical fiber wire 11A14 and the intermittent gear 11A3, and the geared finger link 11A7.

The intermittent gear 11A3, which is a part of the driving force transmission part 11A22, has an intermittent part 11A23, which is a missing part of teeth, and the geared finger link 11A7, which is also a part of the driving force transmission part, includes a gear part 11A24 to be meshed with the intermittent gear 11A3 and a link 11A25 connecting the gear part 11A24 and the fingertip part 11A4.

Since the intermittent gear 11A3 has the intermittent part 11A23, a coupling state in which the gears are meshed with each other and a release state in which the gears are not meshed with each other are switched between the intermittent gear and the gear part 11A24 of the geared finger link 11A7 according to a rotation degree of the intermittent gear 11A3. In the coupling state, the driving force of the high-output actuator 11A1 is transmitted to the fingertip part 11A4, but is not transmitted in the release state.

In other words, the intermittent gear 11A3 and the geared finger link 11A7 have a disconnection mechanism that can also cut off driving force transmission between the high-output actuator 11A1 and the fingertip part 11A4 by providing the intermittent part 11A23 in the intermittent gear 11A3. FIG. 1 shows a state where the driving force transmission is cut off. Accordingly, if the low-output actuator 11A2 roughly operates the fingertip part 11A4 and transmits the driving force of the high-output actuator 11A1 to the fingertip part 11A4 only when a large force is required, a stroke of the high-output actuator 11A1 required in a case where the driving force is always transmitted becomes unnecessary.

In addition, in a state where transmission of the driving force of the high-output actuator 11A1 is cut off, the low-output actuator 11A2 can operate the fingertip part 11A4 without being affected by the high-output actuator 11A1. In other words, the low-output actuator 11A2 can operate without receiving resistance caused by connection with the high-output actuator 11A1. For this reason, it is possible to accurately perform work requiring high controllability and delicate adjustment of force. Furthermore, in a state where the driving force of the high-output actuator 11A1 is transmitted, by adjusting position and force by the low-output actuator 11A2 while operating the high-output actuator 11A1, it is also possible to perform manual work that achieves both work requiring a large force and work requiring high controllability.

Next, the configuration of the robot hand 1 according to the present embodiment will be specifically described. FIG. 2 is a view showing a more detailed configuration of the robot hand 1 of the present embodiment. The robot hand 1 has: a base part 10 that collectively fixes a plurality of finger parts 11A, 11B, and 11C and also serves as connection part when the robot hand 1 is attached to the robot arm; three finger base parts 11A5, 11B5, and 11C5; and the three finger parts 11A, 11B, and 11C that can grip and release a grip target object by approaching or separating from each other. Each of the finger base parts 11A5, 11B5, and 11C5 is fixed to a lower surface of the base part 10. The finger parts 11A, 11B, and 11C each have an end on a side opposite to its fingertip connected to the finger base parts 11A5, 11B5, and 11C5, respectively.

The robot hand 1 also includes the pneumatic artificial muscle 11A1 fixed to a side surface of the finger base part 11C5 and having an end on a side opposite to the fixed part connected to the chemical fiber wire 11A14 of the driving force transmission part 11A22. Similarly, the robot hand 1 includes a pneumatic artificial muscle 11B1 fixed to a side surface of the finger base part 11A5 and having an end on a side opposite to the fixed part connected to the chemical fiber wire 11B14 of a driving force transmission part 11B22. The robot hand 1 further includes a pneumatic artificial muscle 11C1 fixed to a side surface of the finger base part 11B5 and having an end on a side opposite to the fixed part connected to the chemical fiber wire 11C14 of a driving force transmission part 11C22.

The pneumatic artificial muscle 11A1 is formed of a tube of an elastic material such as rubber, and contracts in an axial direction by supply and pressurizing of a fluid such as compressed air to generate force of traction like a human muscle. Instead of the pneumatic artificial muscle, another linear motion actuator such as an oil hydraulic artificial muscle or a pneumatic cylinder can be used as the high-output actuator 11A1.

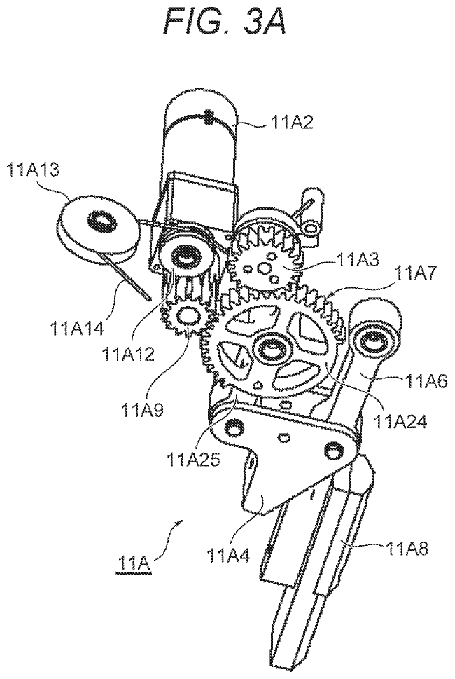

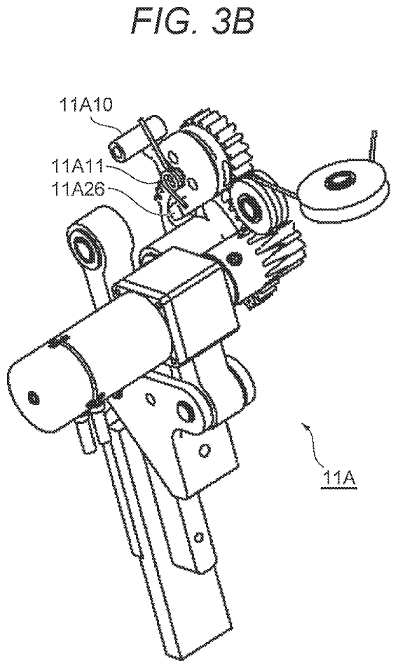

Next, an internal configuration of the finger part will be described with reference to FIGS. 3A and 3B. The finger part 11A includes a finger link 11A6 and the fingertip part 11A4. The finger link 11A6 is made of, for example, aluminum, and a proximal end thereof is rotatably supported by the finger base part 11A5. A most part of the fingertip part 11A4 is configured with, for example, a plurality of aluminum parts, and is connected to the finger link 11A6 and the link 11A25 of the geared finger link 11A7 so as to be rotatable with each other. The link 11A25 of the geared finger link 11A7 has a proximal end rotatably supported by the finger base part 11A5, and has a distal end rotatably supported by the fingertip part 11A4. The gear part 11A24 is rotatably fixed to the proximal end of the link 11A25 integrally with the link 11A25. The gear part 11A24 of the geared finger link 11A7 is fixed to the link 11A25 as to have a central axis located coaxially with a support shaft supporting the proximal end of the link 11A25, and is configured to be turnably driven by turn of the intermittent gear 11A3. Furthermore, the gear part 11A24 is also a driven gear that rotates following movement of the fingertip part 11A4.

As described above, the finger base part 11A5, the finger link 11A6, the geared finger link 11A7, and the fingertip part 11A4 are connected so as to be rotatable with respect to each other, thereby configuring a parallel link of one degree of freedom which swings on the same plane as a plane on which the gear part 11A24 of the geared finger link 11A7 turns. Specifically, the link 11A25 of the geared finger link 11A7 is a drive link driven by turn of the gear part 11A24, the fingertip part 11A4 is an intermediate link, and the finger link 11A6 is a driven link.

The finger part 11A includes a fingertip flexible part 11A8 connected to the fingertip part 11A4. The fingertip flexible part 11A8 is made of, for example, a soft resin such as urethane rubber, and enables gripping of a heavy object by a large frictional force after the finger parts 11A, 11B, and 11C move in a direction of approaching each other to come into contact with a gripping target object.

The number of the finger parts is not limited to three, and may be two, five, or the like. In addition, one pneumatic artificial muscle 11A1 may be connected to all the finger parts instead of being connected to each finger part. In addition, a sensor capable of measuring force may be mounted, such as a load cell mounted inside the fingertip part 11A4 or a tactile sensor mounted on the fingertip flexible part 11A8.

Furthermore, the finger part 11A is connected to the electric motor 11A2 fixed to the finger base part 11A5 via the geared finger link 11A7 and the electric motor gear 11A9. The electric motor 11A2 is, for example, a brushless DC motor, and turnably drives the gear part 11A24 of the geared finger link 11A7 via the electric motor gear 11A9 to transmit driving force to the fingertip part 11A4. Since a planetary gear reducer, which is mounted on the electric motor 11A2, has a reduction ratio as small as about 1:10, a high speed, and a small torque loss, fine force control and position control can be suitably realized. In addition, a rotation rate sensor is mounted on the electric motor 11A2, and the rotation rate can be measured. This enables measurement of a rotation angle of the geared finger link 11A7 and a position of the fingertip part 11A4.

Furthermore, the finger part 11A is connected to the intermittent gear 11A3 via the geared finger link 11A7. The intermittent part 11A23 of the intermittent gear 11A3 is designed to have such a positional relationship that when the pneumatic artificial muscle 11A1 is not driven, the intermittent part is opposed to the gear part 11A24 of the geared finger link 11A7 and does not mesh with the gear part, and only when the pneumatic artificial muscle 11A1 is driven, the intermittent part meshes with the gear part 11A24. Although an arrangement position of the intermittent part 11A23 in the intermittent gear 11A3 and a proportion thereof in an entire circumference are not particularly limited, the intermittent part is preferably designed so as to be meshed with the gear part 11A24 of the geared finger link 11A7 when the pneumatic artificial muscle 11A1 is driven to start contraction and such that a circumference of a tooth part of the intermittent gear 11A3 does not become less than a contraction limit length of the pneumatic artificial muscle 11A1. Instead of the intermittent gear 11A3, an intermittent rack gear with a partially missing tooth can be used.

As described above, the pneumatic artificial muscle 11A1 is connected to the finger part 11A, more specifically, one end of the chemical fiber wire 11A14 is connected to the pneumatic artificial muscle 11A1. Then, the other end of the chemical fiber wire 11A14 is connected to the intermittent gear 11A3 via intermediary pulleys 11A12 and 11A13 made of, for example, ABS resin. In this manner, the driving force (contraction force) of the pneumatic artificial muscle 11A1 is transmitted to the driving force transmission part 11A22 including the intermittent gear 11A3 via the chemical fiber wire 11A14 to drive the fingertip part 11A4.

As illustrated in FIG. 3B, a torsion spring 11A11 is provided on a back surface of the intermittent gear 11A3. The torsion spring 11A11 is fixed by inserting a coil part into a guide rod fixed in the vicinity of the center of the back surface of the intermittent gear 11A3. Then, the torsion spring is used with its arm parts hooked on a protrusion 11A26 provided on the back surface of the intermittent gear 11A3 and on, for example, a DURACON made stopper 11A10 fixed to the finger base part 11A5. This causes generation of a torque (counterclockwise in FIG. 3A) in the intermittent gear 11A3, the torque being in a direction in which a tooth part of the gear part 11A24 is constantly disposed at a position of the intermittent part 11A23 of the intermittent gear 11A3.

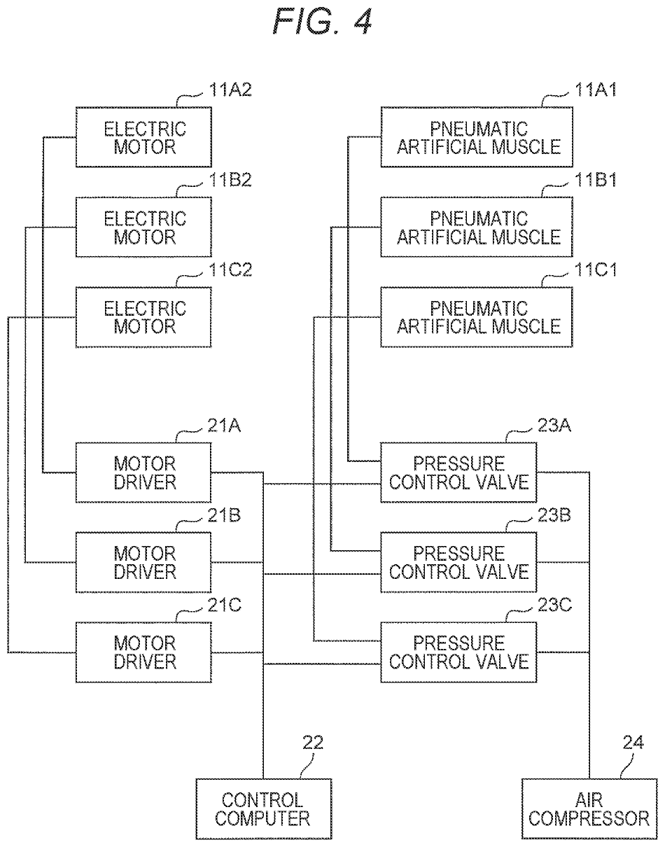

FIG. 4 is a schematic diagram for explaining a control unit of the electric motors 11A2, 11B2, and 11C2 and the pneumatic artificial muscles 11A1, 11B1, and 11C1. Motor drivers 21A, 21B, and 21C are connected to the electric motor 11A2, and a control computer 22 is connected to each motor driver. The motor drivers 21A, 21B, and 21C can control current, speed, position, and the like of the electric motors 11A2, 11B2, and 11C2 on the basis of a command of the control computer 22.

The pneumatic artificial muscles 11A1, 11B1, and 11C1 are connected to an air compressor 24 via pressure control valves 23A, 23B, and 23C, respectively. The present invention is not limited to this configuration, and other pneumatic devices such as a quick exhaust valve, a pressure reducing valve, and a tank may be interposed in the middle. In addition, other electromagnetic valves such as a flow control valve and an on-off valve may be used instead of the pressure control valve. The pressure control valves 23A, 23B, and 23C are connected to the control computer 22, and can control a pressure applied to the pneumatic artificial muscles 11A1, 11B1, and 11C1 on the basis of the command of the control computer 22.

The motor drivers 21A, 21B, and 21C, the control computer 22, the pressure control valves 23A, 23B, and 23C, and the air compressor 24 may be mounted on the robot hand 1 or may be outside the robot hand 1.

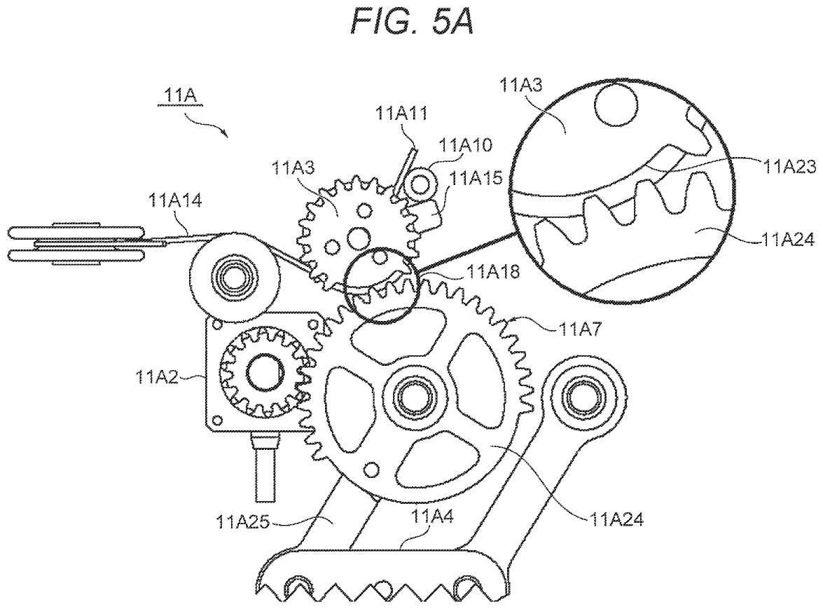

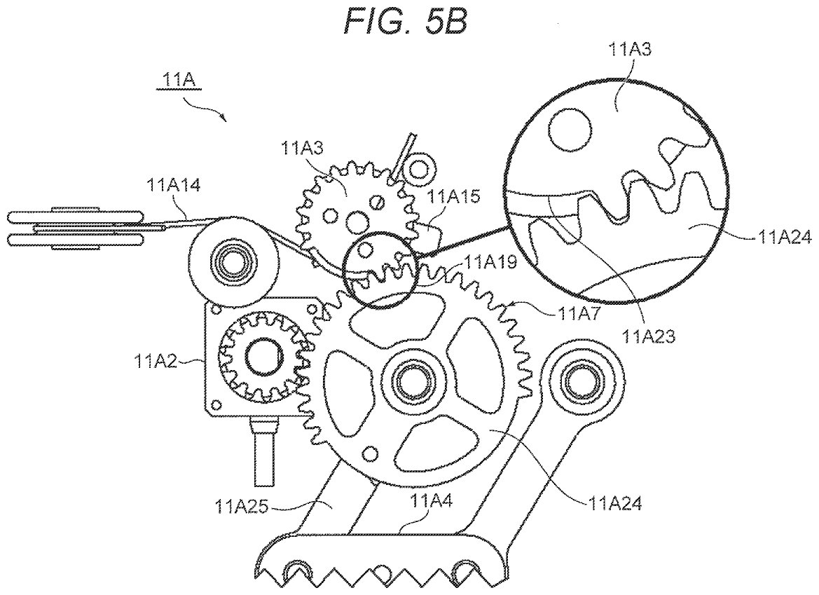

Specific operation of the robot hand 1 having the above configuration will be described. FIGS. 5A and 5B are views for explaining a mechanism of transmitting and cutting off the driving force of the pneumatic artificial muscle 11A1. First, as shown in FIG. 5A, although when the pneumatic artificial muscle 11A1 connected to a distal end of the chemical fiber wire 11A14 is not driven, i.e., in a state where with no pressure applied, the pneumatic artificial muscle 11A1 is not contracted, the intermittent gear 11A3 receives the counterclockwise torque by the torsion spring 11A11, the intermittent gear 11A3 does not rotate any more counterclockwise as the protrusion 11A26 provided on a back surface of the intermittent gear 11A3 comes into contact with the stopper 11A10 fixed to the finger base part 11A5.

In this state, the intermittent part 11A23 of the intermittent gear 11A3 is opposed to the gear part 11A24 of the geared finger link 11A7. In other words, the gear part 11A24 of the geared finger link 11A7 is disposed in the intermittent part 11A23 of the intermittent gear 11A3. Accordingly, the intermittent gear 11A3 and the gear part 11A24 are not meshed, and a pneumatic driving force from the pneumatic artificial muscle 11A1 is cut off (see reference sign 11A18). In other words, since coupling between the intermittent gear 11A3 and the gear part 11A24 of the geared finger link 11A7 is in the release state, the driving force of the pneumatic artificial muscle 11A1 is cut off with respect to the fingertip part 11A4.

In this state, the fingertip part 11A4 can be driven only by the electric motor 11A2. Since the electric motor 11A2 is designed with a low reduction ratio, high-speed finger motion, and precise position and force control are possible.

Next, when the pneumatic artificial muscle 11A1 is driven by a command of pressure input, the pneumatic artificial muscle 11A1 contracts to apply a clockwise torque to the intermittent gear 11A3 via the chemical fiber wire 11A14. Then, as illustrated in FIG. 5B, the tooth part of the intermittent gear 11A3 and the gear part 11A24 of the geared finger link 11A7 mesh with each other, and the driving force is transmitted to the fingertip part 11A4 (see reference sign 11A19). In this state, a very large driving force by the pneumatic artificial muscle 11A1 is transmitted to the fingertip part 11A4 to enable a heavy object to be gripped and moved. At this time, by simultaneously using the electric motor 11A2, feedback control with a quick response can be performed, and precise position and force control that is difficult only with the pneumatic artificial muscle 11A1 having poor responsiveness can also be performed.

Thereafter, when a large force becomes unnecessary, the pressure input by the pneumatic artificial muscle 11A1 is cut off. Then, the contraction force of the pneumatic artificial muscle 11A1 disappears, and a force acts to return to the original state illustrated in FIG. 5A by the counterclockwise torque of the torsion spring 11A11. However, in this state, the tooth part of the intermittent gear 11A3 and the gear part 11A24 of the geared finger link 11A7 are still in a meshing state, and the intermittent gear 11A3 does not move. Therefore, the electric motor 11A2 rotates the gear part 11A24 of the geared finger link 11A7 clockwise to open the fingertip part 11A4. Then, at the same time, the intermittent gear 11A3 also rotates counterclockwise, so that the coupling state with the gear part 11A24 of the geared finger link 11A7 is released. As a result, the intermittent gear 11A3 becomes rotatable and returns to the state of FIG. 5A by the counterclockwise torque applied by the torsion spring 11A11. Thus, in the present embodiment, since the torsion spring 11A11 is used, while an actuator dedicated for driving force connection and disconnection is unnecessary, another actuator for transmission and cut-off of a driving force may be mounted. In that case, it is not necessary to dispose a torsion spring.

As described above, in the present embodiment, by switching between the driving and the stopping of the driving of the pneumatic artificial muscle 11A1, the coupling state 11A19 between the intermittent gear 11A3 and the gear part 11A24 of the geared finger link 11A7 and the release state 11A18 thereof are switched. Then, since in the coupling state 11A19, the intermittent gear 11A3 and the gear part 11A24 of the geared finger link 11A7 are integrally rotatable, the driving force of the pneumatic artificial muscle 11A1 is transmitted to the fingertip part 11A4. On the other hand, in the release state 11A18, since the gear part 11A24 of the geared finger link 11A7 is freely rotatable with respect to the intermittent gear 11A3, the fingertip part 11A4 can be driven only by the electric motor 11A2.

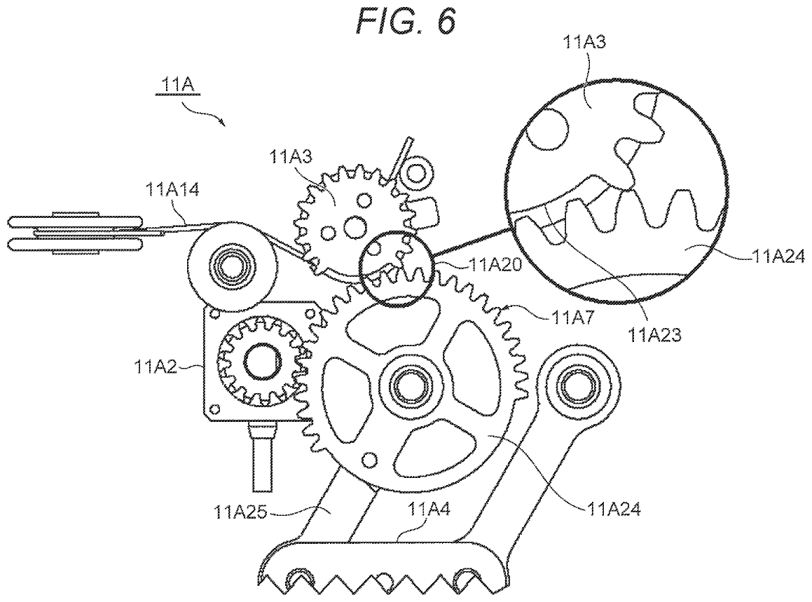

The above description shows the case where a gear part of the intermittent gear 11A3 and the gear part 11A24 of the geared finger link 11A7 mesh with each other without any problem when the pneumatic artificial muscle 11A1 is driven. In some cases, however, as shown in FIG. 6, when the pneumatic artificial muscle 11A1 is driven, the gear part 11A24 of the geared finger link 11A7 and tooth tips of the intermittent gear 11A3 may come into contact with each other and may not be properly meshed (reference sign 11A20). Even if a large pressure is input to the pneumatic artificial muscle 11A1 in this situation, no torque is transmitted to the geared finger link 11A7. Furthermore, since a large frictional force is generated between the intermittent gear 11A3 and the gear part 11A24 of the geared finger link 11A7, even if the electric motor 11A2 is used, the gear part 11A24 of the geared finger link 11A7 cannot be rotated.

One means for avoiding this situation is to set several angle ranges of the gear part 11A24 that can be meshed with the gear part of the intermittent gear 11A3 in advance. Then, after controlling the geared finger link 11A7 to the meshing angle using the rotation rate sensor mounted on the electric motor 11A2, the pneumatic artificial muscle 11A1 may be driven. At this time, it is not always necessary to set all the angle ranges in advance, and with a certain range input, it is also possible to set a range obtained by shifting the range by a pitch multiple of teeth of the geared finger link 11A7.

Other means for avoiding the situation includes first inputting a small pressure (e.g., 0.1 MPa) to the pneumatic artificial muscle 11A1 to rotate the intermittent gear 11A3.

Then, even if the geared finger link 11A7 and the intermittent gear 11A3 do not mesh with each other as illustrated in FIG. 6, friction generated therebetween is small. Therefore, the geared finger link 11A7 can be rotated counterclockwise by the electric motor 11A2 to enable both the gears to be meshed. Thereafter, when a large pressure (e.g., 0.6 MPa) is input to the pneumatic artificial muscle 11A1, a large driving force can be transmitted to the fingertip part 11A4.

The above connection and disconnection of the pneumatic power can be similarly performed for the finger parts 11B and 11C. In the case of the present embodiment, each of the finger parts 11A, 11B, and 11C can independently perform the above operation.

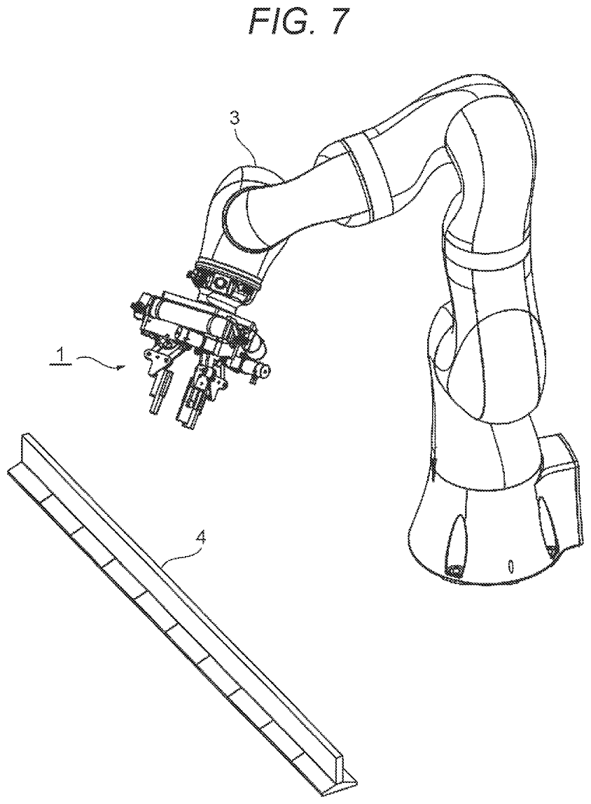

Next, an example of a method of transporting a heavy object by the robot hand 1 will be described with reference to FIGS. 7 to 9. FIG. 7 illustrates a state of the entire device in the present embodiment. The robot hand 1 according to the above embodiment is mounted on a distal end of a robot arm 3 and transports a long object 4. Position and attitude of the robot hand 1 can be freely controlled by the robot arm 3. The robot arm 3 may be another machine that controls the position and the attitude, such as a three-axis slider. The long object 4 is, for example, an iron rail having a length of 1 m and a weight of 10 kg.

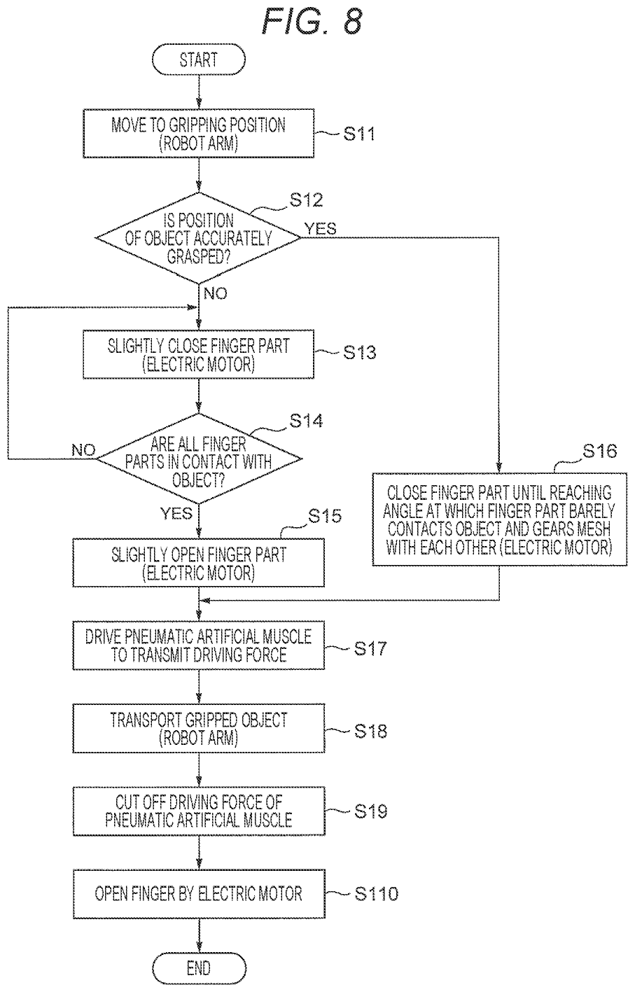

FIG. 8 is a flowchart showing a sequence of transporting the long object 4. At the start, no pressure input is commanded to the pneumatic artificial muscles 11A1, 11B1, 11C1, and the gear parts 11A24, 11B24, 11C24 of the geared finger links 11A7, 11B7, 11C7 and the intermittent gears 11A3, 11B3, 11C3 are not meshed.

First, the robot hand 1 is moved to a gripping position using the robot arm 3 (S11). The next flow branches depending on whether a position of the long object 4 is accurately grasped or not (S12). When not accurately grasped, the electric motors 11A2, 11B2, and 11C2 are driven to gradually close the finger parts 11A, 11B, and 11C of the robot hand 1 (S13).

Contact between the finger parts 11A, 11B, and 11C and the long object 4 is sequentially confirmed, and the closing is stopped when the contact between all the finger parts 11A, 11B, and 11C and the long object 4 is detected (S14). The contact can be detected when a change in an encoder value of the electric motor 11A2, 11B2, 11C2 stops or when a current value flowing through the electric motor 11A2, 11B2, 11C2 increases.

Stopping the closing after confirming the contact between the finger parts 11A, 11B, and 11C and the long object 4 may be replaced by a method of controlling an output of the electric motor 11A2, 11B2, 11C2, simply continuously sending a command to close the finger for a fixed period of time, and stopping the closing when a certain period of time elapses. In addition, after confirming the contact between all the finger parts and the long object 4 without stopping the operation of closing the finger parts, the output of the electric motor 11A2, 11B2, 11C2 may be increased to drag the long object as it is.

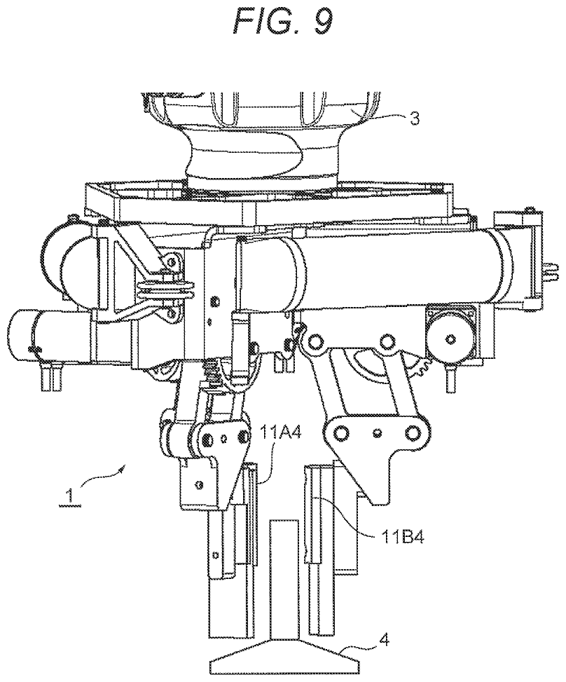

Thereafter, the pneumatic artificial muscles 11A1, 11B1, and 11C1 are driven to grip and transport the long object 4. Therefore, it is necessary to appropriately mesh the tooth parts of the intermittent gears 11A3, 11B3, and 11C3 with the geared finger links 11A7, 11B7, and 11C7, respectively. Therefore, after confirming the contact of all the finger parts 11A, 11B, and 11C with the long object 4, the electric motors 11A2, 11B2, and 11C2 are used to slightly open all the finger parts 11A, 11B, and 11C to an extent that the intermittent gears 11A3, 11B3, and 11C3 can be meshed with the gear parts 11A24, 11B24, and 11C24 of the geared finger links 11A7, 11B7, and 11C7 (S15), thereby bringing the finger parts 11A, 11B, and 11C to be slightly separated from the long object 4 as illustrated in FIG. 9.

Thereafter, the pneumatic artificial muscles 11A1, 11B1, and 11C1 are driven to transmit a large gripping force to the fingertip part 11A4 to grip the long object 4 (S17). Thereafter, the gripped object is transported by the robot arm (S18), and after the driving force of the pneumatic artificial muscle is cut off (S19), the finger is opened by the electric motor to be separated from the long object 4 (S110), whereby transportation work of the long object 4 is completed.

Unlike the above processing, when the position of the long object 4 and the gripping position thereof are accurately grasped in Step S12, the robot arm 3 can be moved so that a center position or a gravity center position of the finger part 11A, 11B, 11C and a gripping position of the long object 4 coincide with each other. In this case, after the robot arm 3 is moved, the finger parts 11A, 11B, and 11C are driven by the electric motor to a position where the finger parts barely contact the object and the tooth part of the intermittent gear 11A3 and the geared finger link 11A7 mesh with each other (S16). The subsequent operation is the same as that described above.

There are two advantages of adopting the disconnection mechanism that switches transmission and cut-off of the driving force, which is a characteristic of the present invention, on the assumption of this grasping sequence. The first advantage is that the strokes of the pneumatic artificial muscles 11A1, 11B1, and 11C1 can be significantly reduced. When the pneumatic artificial muscles 11A1, 11B1, and 11C1 are constantly connected without the disconnection mechanism, it is necessary to secure, in the pneumatic artificial muscles 11A1, 11B1, and 11C1, the strokes for opening and closing the finger parts 11A, 11B, and 11C.

In general, a pneumatic actuator needs to have an increased pressure receiving area in order to apply a force, and needs to have an increased total length in order to increase a stroke. Therefore, the pneumatic actuator becomes huge to have an increased weight, so that it is difficult to mount the pneumatic actuator on the robot hand. In particular, when a pneumatic artificial muscle is used, since its amount of contraction is only 30% at the maximum, a long artificial muscle is required to secure a stroke.

However, in a case where the disconnection mechanism of the present invention is adopted, it is not necessary to secure a corresponding stroke by cutting off the driving force of the pneumatic actuator when the disconnection mechanism can be operated only by driving the electric motor. Then, since the pneumatic actuator is driven (contracted) only when the pneumatic actuator needs to be driven, the stroke can be suppressed to be small to make the pneumatic actuator be compact and lightweight, so that the pneumatic actuator can be satisfactorily mounted on the robot hand.

As the second advantage, the pneumatic artificial muscles 11A1, 11B1, and 11C1 can exhibit maximum force. In general, a pneumatic artificial muscle has a characteristic that a contraction force is weakened as it contracts. Therefore, when the pneumatic artificial muscles 11A1, 11B1, and 11C1 are constantly connected to the finger parts without using the disconnection mechanism, the pneumatic artificial muscles 11A1, 11B1, and 11C1 also contract with the driving of the electric motor. Therefore, when the finger is closed until the finger approaches a gripping target object, the pneumatic artificial muscles 11A1, 11B1, and 11C1 are contracted to some extent, and the contraction force is already reduced.

Therefore, the gripping force cannot be sufficiently exerted, and a heavy object cannot be gripped. However, when the disconnection mechanism of the present invention is adopted and an object is gripped in the above-described sequence, the pneumatic artificial muscles 11A1, 11B1, and 11C1 can grip any size object in a slightly contracted state, so that a large gripping force can be exerted.

In the present embodiment, a pneumatic artificial muscle is employed as a pneumatic actuator. As an advantage thereof, the pneumatic artificial muscle is lighter in weight and lower in cost than a commonly used pneumatic cylinder or the like. When a robot hand has an increased weight, a payload decreases accordingly, and therefore the robot hand is required to be lightweight. However, use of a pneumatic artificial muscle can realize static hybrid driving in a lightweight robot hand. Note that artificial muscles are also present in oil pressure and water pressure, and a configuration using such artificial muscles can also provide similar advantages. Although oil pressure and water pressure invite an increase in a size of a peripheral equipment, they have an advantage that a larger force than air pressure can be exerted.

In a state where the driving forces of the pneumatic artificial muscles 11A1, 11B1, and 11C1 are completely cut off, the fingertip parts 11A4, 11B4, and 11C4 can be driven only by the electric motors 11A2, 11B2, and 11C2, respectively. Therefore, due to high control performance of the electric motors 11A2, 11B2, and 11C2, the fingertip parts 11A4, 11B4, and 11C4 can be driven with high accuracy, and a delicate grip target object can be gripped without being damaged.

In a state in which the driving forces of the pneumatic artificial muscle 11A1, 11B1, and 11C1 are transmitted, by performing feedback control of the position and force by the electric motors 11A2, 11B2, and 11C2 while the pneumatic artificial muscles 11A1, 11B1, and 11C1 exert a large force, both a large force and control performance can be achieved as well.

### Second Embodiment

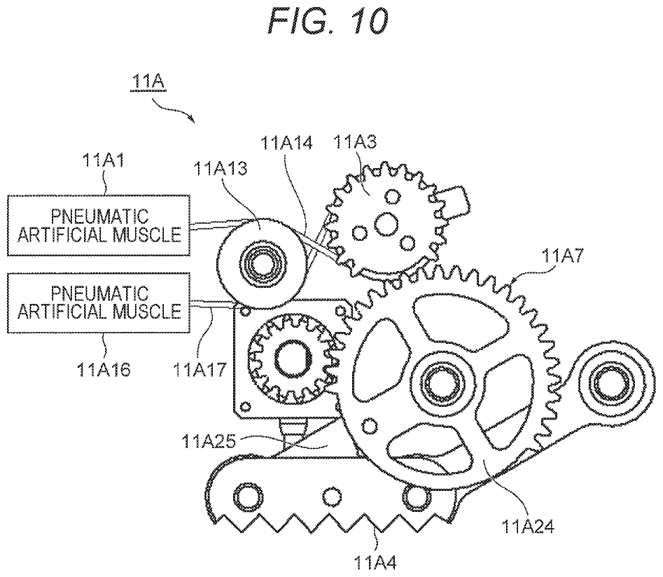

A robot hand 1 according to a second embodiment of the present invention will be described with reference to FIG. 10. The robot hand 1 according to the second embodiment will be mainly described with reference to differences from the robot hand 1 according to the first embodiment. The robot hand 1 described in the first embodiment can exert a large force in a direction of closing the finger parts 11A, 11B, and 11C, but cannot exert a large force in a direction of opening them.

Therefore, for example, it is not possible to insert the finger parts 11A, 11B, and 11C into pits of a heavy part and hold the heavy part by the force in the opening direction. However, this can be solved by adopting a configuration according to the present embodiment. FIG. 10 is a schematic view illustrating an internal structure of the finger part 11A of the robot hand 1 according to the present embodiment. Similarly to the robot hand 1 of the first embodiment, the chemical fiber wire 11A14 has one end connected to the pneumatic artificial muscle 11A1, is wound around the intermittent gear 11A3 via the intermediary pulley 11A13, and has a terminal end connected to the intermittent gear 11A3.

In addition to the pneumatic artificial muscle 11A1, the finger part 11A according to the present embodiment is connected to another pneumatic artificial muscle 11A16 via a chemical fiber wire 11A17. The chemical fiber wire 11A17 has one end connected to the pneumatic artificial muscle 11A16, is wound around the intermittent gear 11A3 via the intermediary pulley 11A13, and has a terminal end connected to the intermittent gear 11A3. In other words, the pneumatic artificial muscles 11A1 and 11A16 head-to-head drive the intermittent gear 11A3 turnably in directions opposite to each other.

When the pressure is input to the pneumatic artificial muscle 11A1 in this state, as in the first embodiment, the intermittent gear 11A3 rotates clockwise, meshes with the geared finger link 11A7 to transmit the driving force, so that a large force can be exerted in the direction of closing the fingertip part 11A4.

In the first embodiment, the torsion spring 11A11 is used to cut off the driving force of the pneumatic artificial muscle 11A1 when a large driving force by the pneumatic artificial muscle 11A1 becomes unnecessary. Specifically, the torque in the counterclockwise direction is applied to the intermittent gear 11A3 by the torsion spring 11A11 to return the intermittent gear 11A3 in the coupling state with the gear part 11A24 of the geared finger link 11A7 (see 11A19 in FIG. 5B) to the release state (see 11A18 in FIG. 5A). However, in the present embodiment, the pneumatic artificial muscle 11A16 contracts by driving of the pneumatic artificial muscle 11A16, which enables the torque to be applied to the intermittent gear 11A3 in the counterclockwise direction. Since this enables the intermittent gear 11A3 to be returned to the original position (release state), no torsion spring is necessary.

In addition, since the pneumatic artificial muscles 11A1 and 11A16 constitute antagonistic drive with respect to the intermittent gear 11A3, an angle of the intermittent gear 11A3 can be easily controlled by adjusting pressures of both the pneumatic artificial muscles. It is not necessary to perform feedback control with a sensor mounted, and it is only necessary to record a pressure and perform the same pressure input every time.

In addition, when pressure is input this time to the pneumatic artificial muscle 11A16 in a driving force cut-off state, the intermittent gear 11A3 rotates counterclockwise and is power-connected to the geared finger link 11A7. At this time, a large force can be exerted in the direction of opening the finger part 11A. Therefore, this enables, for example, the robot hand to be inserted into a pit part provided in a heavy object, and enables the heavy object to be held and moved by the force in the direction of opening the finger part.

The finger parts 11B and 11C may have the same configuration as the finger part 11A according to the present embodiment, or may have the configuration described in the first embodiment. Contrary to the first embodiment, a large force may be exerted only in the direction of opening the finger part.

According to the embodiments of the present invention described in the foregoing, the following functions and effects are achieved.
(1) The robot hand 1 includes the finger part 11A, and a driving unit that drives the finger part 11A. The driving unit includes the plurality of driving actuators 11A1 and 11A2, and the driving force transmission part 11A22 that transmits driving forces of the plurality of driving actuators to the finger part. The driving force transmission part 11A22 includes a disconnection mechanism 11A21 that selectively switches between the coupling state 11A19 in which the driving actuator 11A1 among the plurality of driving actuators 11A1 and 11A2 is coupled to the finger part 11A, and the release state 11A18 in which the coupling between the driving actuator 11A1 and the finger part 11A is released to switch between transmission of a driving force of the driving actuator 11A1 to the finger part 11A and cut-off thereof.

As a result, the driving actuator 11A1 is connected to the driving force transmission part only at the time of gripping a target object, so that a stroke required for operation can be greatly reduced. Therefore, it is possible to realize a robot hand having excellent gripping force and controllability while being small in size and light in weight.
(2) The disconnection mechanism 11A21 switches between the coupling state 11A19 and the release state 11A18 by switching between driving and stopping of the driving of the driving actuator 11A1. This eliminates a need of separately preparing a member for operating the disconnection mechanism, and enables an increase in cost and space to be suppressed.
(3) The disconnection mechanism 11A21 has the intermittent gear 11A3 that is turnably driven by the driving actuator 11A1, and the gear part 11A24 of the geared finger link 11A7 that is turned by movement of the finger part 11A.

In the coupling state 11A19, the tooth part of the intermittent gear 11A3 and the gear part 11A24 of the geared finger link 11A7 are meshed with each other to enable the intermittent gear 11A3 and the gear part 11A24 of the geared finger link 11A7 integrally rotate. In the release state 11A18, the gear part 11A24 of the geared finger link 11A7 is disposed in the intermittent part 11A23 of the intermittent gear 11A3 to enable the gear part 11A24 of the geared finger link 11A7 to freely rotate with respect to the intermittent gear 11A3. Therefore, the disconnection mechanism can be easily obtained by adjusting shapes of the two gears constituting the driving force transmission part without requiring complicated processes and high costs.
(4) The plurality of driving actuators includes the first driving actuator 11A1 that turnably drives the intermittent gear 11A3 and the second driving actuator 11A2 that turnably drives the gear part 11A24 of the geared finger link 11A7, and the first driving actuator 11A1 has a driving force larger than a driving force of the second driving actuator 11A2. As a result, since the driving actuator 11A1 having a large driving force is connected to the driving force transmission part only when being driven, it is not necessary to secure an extra stroke, thereby suppressing an increase in size and weight of the device.
(5) The robot hand 1 further has the control computer 22 that drives the first driving actuator 11A1 and the second driving actuator 11A2. The control computer 22 performs control of causing the first driving actuator 11A1 to turnably drive the intermittent gear 11A3 to bring the disconnection mechanism into the release state 11A18, causing the second driving actuator 11A2 to turnably drive the gear part 11A24 of the geared finger link 11A7 to bring the finger part 11A close to a position opposed to a target object, and causing the first driving actuator 11A1 to turnably drive the intermittent gear 11A3 to bring the disconnection mechanism into the coupling state 11A19, and bring the finger part 11A into contact with the target object to grip the target object. As a result, until immediately before the target object is gripped, the finger part 11A is driven only by the second driving actuator 11A2 having a relatively small driving force, so that the operation can be performed with high accuracy.
(6) The first driving actuator is the pneumatic artificial muscle 11A1 that turns the intermittent gear 11A3 in a clockwise direction by contraction to mesh the tooth part of the intermittent gear 11A3 with the geared finger link 11A7, thereby turning the gear part 11A24 of the geared finger link 11A7, and the second driving actuator is the electric motor 11A2 that turns the gear part 11A24 of the geared finger link 11A7 by driving. Since the robot hand according to the present invention has the driving force disconnection mechanism as described in the above embodiments, it is possible to adopt a pneumatic artificial muscle that has been difficult to be mounted on a robot hand.
(7) The disconnection mechanism 11A21 has the torsion spring 11A11 that turnaly drives the intermittent gear 11A3 in a counterclockwise direction to release the meshing between the tooth part of the intermittent gear 11A3 and the gear part 11A24 of the geared finger link 11A7 when the pneumatic artificial muscle 11A1 extends in a contracted state. As a result, switching between the coupling state and the release state of the disconnection mechanism can be realized at a minimum cost without adding an actuator or the like.
(8) The driving unit further has the pneumatic artificial muscle 11A16 that turnably drives the intermittent gear 11A3 in the counterclockwise direction by contraction. As a result, since a large driving force is exerted not only in the direction of closing the finger part 11A but also in the direction of opening the finger part, for example, the finger part can be inserted into a pit part provided in a heavy object to enable the heavy object to be held by a driving force caused by opening of the finger part.
(9) The robot system includes the robot arm 3, and the robot hand 1 described in the above embodiment and connected to a distal end of the robot arm 3. This enables use of the robot hand described in the above embodiment on a spot level such as a factory.

Note that the present invention is not limited to the above-described embodiments, and various design changes can be made without departing from the spirit of the present invention described in the claims. For example, the above embodiments have been described in detail for helping understanding of the present invention, and are not necessarily limited to those having all the described configurations. In addition, a part of the configuration of a certain embodiment can be replaced with the configuration of another embodiment, and to the configuration of the certain embodiment, the configuration of another embodiment can be added. In addition, it is possible to add, delete, and replace other configurations with respect to a part of the configuration of each embodiment.

### REFERENCE SIGNS LIST

1 robot hand
11A1, 11B1, 11C1, 11A16 pneumatic artificial muscle
11A2, 11B2, 11C2 electric motor
11A3, 11B3, 11C3 intermittent gear
11A7, 11B7, 11C7 geared finger link
11A11, 11B11, 11C11 torsion spring
11A18 release state
11A19 coupling state
11A21 disconnection mechanism
11A22 driving force transmission part
11A23 intermittent part
11A24 gear part
22 control computer

1. A robot hand comprising: a finger part; and a driving unit that drives the finger part, wherein the driving unit includes: a plurality of driving actuators; and
a driving force transmission part that transmits driving forces of the plurality of driving actuators to the finger part, the driving force transmission part including
a disconnection mechanism that selectively switches between a coupling state in which some of the plurality of driving actuators and the finger part are coupled and a release state in which the coupling between the some of the driving actuators and the finger part is released to switch between transmission of a driving force of the some of the driving actuators to the finger part and cut-off of the driving force.

2. The robot hand according to claim 1, wherein
the disconnection mechanism s between the coupling state and the release state by switching between driving and stopping of the driving of the some of the driving actuators.

3. The robot hand according to claim 2, wherein
the disconnection mechanism includes: an intermittent gear that is turnably driven by the some of the driving actuators; and
a driven gear turned by movement of the finger part, and wherein
in the coupling state, a tooth part of the intermittent gear and the driven gear are meshed with each other to enable the intermittent gear and the driven gear to integrally rotate, and
in the release state, a tooth part of the driven gear is disposed in an intermittent part of the intermittent gear to enable the driven gear to freely rotate with respect to the intermittent gear.

4. The robot hand according to claim 3, wherein
the plurality of driving actuators includes a first driving actuator that turnably drives the intermittent gear and a second driving actuator that turnably drives the driven gear, and
the first driving actuator has a driving force larger than a driving force of the second driving actuator.

5. The robot hand according to claim 4, further comprising
a control unit that drives the first driving actuator and the second driving actuator, wherein the control unit performs control of:
causing the first driving actuator to turnably drive the intermittent gear to bring the disconnection mechanism into the release state;
causing the second driving actuator to turnably drive the driven gear to bring the finger part close to a position opposed to a target object; and
causing the first driving actuator to turnably drive the intermittent gear to bring the disconnection mechanism into the coupling state, and bring the finger part into contact with the target object to grip the target object.

6. The robot hand according to claim 5, wherein the first driving actuator is a linear motion actuator that turns the intermittent gear in a first direction by contraction to mesh the tooth part of the intermittent gear with the driven gear, thereby turning the driven gear, and
the second driving actuator is a motor that turns the driven gear by driving.

7. The robot hand according to claim 6, wherein
the disconnection mechanism includes
a return spring that turnaly drives the intermittent gear in a second direction opposite to the first direction to release the meshing between the tooth part of the intermittent gear and the driven gear when the linear motion actuator extends in a contracted state.

8. The robot hand according to claim 6, wherein
the driving unit further includes a second linear motion actuator that turnably drives the intermittent gear in a second direction opposite to the first direction by contraction.

9. A robot system comprising:
a robot arm; and
a robot hand connected to a distal end of the robot arm, wherein
the robot hand is the robot hand according to claim 1.
